(19) United States
(12) Patent Application Publication
(10) Pub. No.: US 2026/0364393 A1
(43) Pub. Date: Nov. 19, 2026

(54) Fire Protection And Suppression Composition And Related Methods

(71) Applicant: Kelly Wheeler, Lompoc, CA (US)

(72) Inventor: Kelly Wheeler, Lompoc, CA (US)

(21) Appl. No.: 19/644,964

(22) Filed: Apr. 10, 2026

Related U.S. Application Data
(60) Provisional application No. 63/786,700, filed on Apr. 10, 2025.

(51) Int. Cl. A62D 1/00; A62C 3/02; B64D 1/18; B64U 10/14

(52) U.S. Cl. CPC A62D 1/0035; A62C 3/0242; B64D 1/18; B64U 10/14

(57) ABSTRACT

The present invention is directed to fire suppression composition including a dry mix of food grade ingredients of approximately 30-50% flour, 5-50% starch, 5-25% simple sugar, 5-50% bicarbonate agent, 0-20% antifreeze including as propylene glycol, and 0-20% hydrate including hyaluronic acid wherein the dry mix is combined with water at a ratio of about 2:1 (dry mix to water) to form a viscous fire suppression and protection agent.

### FIELD OF DISCLOSURE

The present invention relates to a fire protection and suppression composition operable to extinguish and protect from fires. More specifically, the present invention relates to a formula for a fire protection and suppression composition and the methods of preparing and using such composition.

### BACKGROUND

Fire protection and suppression from fires is needed for many settings, especially within residential, industrial, and outdoor settings. Conventional fire protection and suppression systems, including water-based, chemical, and foam-based solutions that have long been employed to extinguish and protect from fires. However, each of these existing methods comes with notable drawbacks that can limit their effectiveness and applicability in certain scenarios.

Water-based fire protection and suppression systems, the most widely used form, are effective in extinguishing small and medium types of fires but require significantly greater amounts for larger fires and come with significant disadvantages. The primary issue with water is that it must be actively and continuously applied to a structure to help protect from wildfire. Then there is the extensive damage it can cause to indoor structures and personal property. Water infiltration can lead to structural weakening, mold growth, and the destruction of sensitive equipment and belongings. Additionally, the large volumes of water often required can exacerbate damage and complicate cleanup efforts, resulting in high repair costs and prolonged restoration periods. And extensive amounts of precious water use are required against large scale wildfires and can dry/dissipate and allow reignition. And the copious amounts of water can counter the floatation ability of marine craft, submarines; air worthiness of aircraft; and enclosed area of spacecraft.

Chemical fire protection and suppression systems, such as those utilizing halon or other extinguishing agents, are often employed in settings where water is impractical, such as in electronics or archival storage. While these chemical agents can be highly effective at rapidly suppressing fires, they often present environmental and safety concerns and are ineffective against heat and smoke or enduring fires. Many traditional chemical agents are toxic, posing significant risks to human health during and after deployment. Furthermore, some chemical suppressants have been shown to contribute to environmental degradation, including ozone depletion and the accumulation of hazardous residues and are ineffective against prolonged fires. In a wildfire situation, chemicals don't adhere to inorganic material like houses, propane tanks, vehicles, etc. and do not protect against heat transfer. They may also cause discoloration and prolonged damage from dyes used. They are dangerous in enclosed environments such as aircraft and spacecraft.

Foam-based fire protection and suppression compositions are also used in various applications, particularly for liquid fuel fires. While foams can be effective in smothering and preventing the reignition of fires, their use is not without challenges. Many commercial foams contain per-and polyfluoroalkyl substances (PFAS), which are persistent in the environment and have been associated with adverse health effects and most are now banned due to toxicity. Cleanup and disposal of such foams can be complicated, necessitating special handling to prevent environmental contamination. Moreover, foams can leave residues that are difficult to remove, leading to potential damage to surfaces and property.

Additionally, many conventional fire protection and suppression systems do not break down readily in outdoor environments, creating long-term environmental concerns when deployed. The residual byproducts of these systems can contaminate water sources and soil, impacting local ecosystems. In cases where these systems are used indoors, their residues can adhere to surfaces and become embedded in porous materials, making post-fire cleanup labor-intensive and costly.

There remains a need for fire protection and suppression compositions and systems that overcome these drawbacks. Such compositions should effectively protect from and suppress fires on inorganic as well as organic materials without causing undue harm to structures (inside or outside) nor personal property, pose minimal environmental impact, not harm life or property, prevent ignition and reignition, prevent heat transfer, and allow for straightforward cleanup. Furthermore, solutions that do not contribute to long-term environmental degradation or pose risks to human health or consume precious water resources would represent a significant advancement in fire safety technology.

Therefore, there exists an ever increasing need for improved fire protection and suppression systems or fire protection and suppression composition.

### SUMMARY

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

The present invention provides a method of making and using a fire protection and suppression composition operable to extinguish and protect from fires. The fire protection and suppression composition may be made from widely available food grade ingredients. For example, the fire protection and suppression composition may be operable to form a barrier over a fire, thereby preventing the fire from absorbing excess oxygen from the surrounding environment and coating the ignited material thereby preventing continued ignition. The composition may be operable to form a semi-rigid material when in contact with the fire, thereby providing an insulating layer against the flames. The semi-rigid material may be knocked off after the fire is extinguished. The composition may be used to coat any type of material to provide a physical barrier that protects against heat, flame, smoke.

The fire protection and suppression composition may be used to suppress fires and prevent ignition or heat and smoke damage over a plurality of target surfaces. Some examples of target surfaces used for this application may include residential homes, businesses, other structures, monuments, exterior surfaces, hallways and corridors, warehouses, fields and lawns, vehicle surfaces, propane tanks, trees, shrubs, grass, vineyards, powerlines, telephone poles and the like.

In some embodiments, the fire protection and suppression composition may be a water-activated mixture operably formed as a spreadable slurry. The spreadable slurry may be operably placed directly over a fire, operably expanding and creating a layer over the fire.

In such embodiments, the spreadable slurry may be operable to cover the entire surface area of the fire, preventing it from growing and reducing its exposure to surrounding oxygen or access to fuel.

In some embodiments, the fire protection and suppression composition may be mixed using common ingredients. For example, the composition may include ingredients such as flour, starch, and sodium bicarbonate. Therefore, users of the fire composition may not require specialized experience or additional tooling. Some users of the fire composition may include fire fighters, emergency responders, industrial workers, residential homeowners, and the like.

The method of making the slurry may involve mixing a plurality of ingredients with water. Some examples of ingredients used within the slurry may include food grade dry ingredients such as polysaccharides, carbohydrates, bicarbonate agents, hydrates, antifreeze, and suitable binders.

In some embodiments, suitable binders may include a primary and secondary binder, for example, not limiting the invention, the primary binder may be a polysaccharide that may include complex carbohydrates. Examples of primary binders may include flour, xanthan gum, guar gum, cellulose, and the like. The secondary binder may be a polysaccharide operable to enhance the viscosity of the mixture. Examples of secondary binders may include corn starch, potato starch, tapioca starch, arrowroot starch, and the like.

In some embodiments, suitable food grade hydrate ingredients may be added for example, not limiting the invention. Examples of hydrates may include Propylene Glycol, Hyaluronic Acid, hydrated lime, calcium hydroxide, Nixtacal or FCC-grade hydrated salts.

In some embodiments, suitable food grade antifreeze ingredients may be added for example, not limiting the invention. Examples of antifreeze may include Propylene Glycol.

As the spreadable slurry contacts a target surface, the slurry may operably cover the entire surface area surrounding the fire, forming a barrier. Therefore, the fire may be prevented from absorbing additional oxygen from the surrounding environment or transferring heat to covered fuel. Once the slurry contacts the fire, the water may evaporate in the composition, leaving a thick layer formed by the primary and secondary binders. As the layer dries, the carbohydrates and polysaccharides undergo transformations from the heat, leading to a flaky material that may be semi-rigid. The bicarbonate agent within the slurry may also undergo a thermal decomposition when heated. In such embodiments, the bicarbonate agent may be sodium bicarbonate. The flaky material left behind may be knocked off using a plurality of methods, including mechanical force, air or water pressure, vibration, or natural disintegration.

In some embodiments, the spreadable slurry mixture may be formed by activating the ingredients with water. The mixture may first be formed by mixing a primary binder, secondary binder, and a bicarbonate agent. For example, the spreadable slurry mixture may have a 2:1:1 ratio with water. Therefore, the total dry composition of the slurry mixture may be divided into three parts: 50% primary binder, 25% secondary binder, and 25% bicarbonate agent.

As the primary binder mixes with water, the carbohydrates swell, thereby creating a viscous structure, allowing the slurry to spread evenly over surfaces. The secondary binder may act as a thickener, improving the stickiness of the mixture. As the bicarbonate agent interacts with water, the cohesion of the slurry may improve, acting as a raising agent. In such embodiments, bicarbonate agents may produce carbon dioxide when heated. Examples of bicarbonate agents may include baking soda, baking powder, potassium bicarbonate, and the like.

To extend the shelf-life of viscous fire protection and suppression compositions, incorporating non-toxic preservatives is essential. Potassium sorbate may be used at concentrations between 0.1% and 0.3% (w/w) to inhibit the growth of mold, yeast, and some bacteria, potentially extending the shelf-life up to 12 months or more without imparting toxicity or altering the composition's properties. Sodium benzoate in concentrations ranging from 0.05% to 0.1% (w/w) may be utilized for microbial growth prevention, offering an estimated shelf-life extension of 9 months or more. Natural antimicrobials, such as rosemary extract at 0.05% to 0.2% (w/w) may provide up to 8 to 10 months of preservation through their inherent antimicrobial and antioxidant properties, making them ideal for eco-friendly formulations. Additionally, a synergistic combination of citric acid (0.1% to 0.2% w/w) and ascorbic acid (0.05% to 0.1% w/w) can extend the shelf-life by 9 to 12 months by adjusting the pH to inhibit microbial growth. Acetic acid can be used at 0.1% to 0.5% (w/w) to naturally lower the pH, resulting in a shelf-life extension of approximately 6 months while being safe and biodegradable. For enhanced preservation, a combination of potassium sorbate (0.1% to 0.2% w/w) and sodium benzoate (0.05% to 0.08% w/w) can be employed, providing up to 18 months of stability through broader-spectrum protection against microbial growth.

In some embodiments, the viscosity of the spreadable slurry may range between 1000 to 3000 centipoise. Therefore, the slurry may be sufficiently flowable to be delivered through a delivery mechanism while still adhering to surfaces affected by fire. In other embodiments, the spreadable slurry may have a different viscosity.

In some embodiments, the spreadable slurry may be operable to extinguish a fire through a delivery mechanism. Due to the thicker, semi-liquid nature of the fire protection and suppression compositions, traditional systems designed for more fluid or gaseous agents may be inadequate. The delivery mechanism may be operable to deploy the spreadable slurry toward a target surface to extinguish a fire. More specifically, the delivery mechanism may be operable to apply the slurry in a controlled and efficient method. Some examples of delivery mechanisms may include airborne delivery systems, aerial drops, pressurized tank sprayers, firefighting vehicles, manual sprayers, peristaltic pumps, foam-based extinguishers, roller-based systems, and the like.

Each delivery mechanism may require a different design element operable to allow for effective transportation and controlled flow of the slurry. For example, some delivery mechanisms may require pressurization systems for thicker and viscous fluids, positive displacement pumps for controlled delivery across large distances. Some mechanisms may also include customized nozzles or orifices operable to prevent clogging and viscosity controls to ensure optimal delivery.

In some embodiments, the spreadable slurry may be operably used within manifold spray systems. The manifold spray system may be a network of pipes or tubes connected to a plurality of nozzles having sufficient nozzle diameters to deliver the slurry. Therefore, as the slurry is transported through the pipes, it may be released at a consistent pressure and flow, thereby allowing for a controlled fire response. Pump-assisted nozzles are another viable option for deploying viscous compositions. These nozzles integrate a mechanical or electric pump that helps move the thicker material through the system. Positive displacement pumps, such as diaphragm or peristaltic pumps, are particularly well-suited due to their ability to handle high-viscosity fluids without significant wear or risk of blockage. These systems can be installed in both hand-held extinguishers and vehicle-mounted units for rapid deployment in various settings.

Pump-assisted nozzles may also be used to deploy the viscous fire protection and suppression compositions. These nozzles integrate a mechanical or electric pump that helps move the viscous material through hoses, pipes, and/or or nozzles. Positive displacement pumps, such as diaphragm or peristaltic pumps, are particularly well-suited due to their ability to handle high-viscosity fluids without significant wear or risk of blockage. These systems can be installed in both hand-held extinguishers and vehicle-mounted units for rapid deployment in various settings. Such pumps may also be used in systems installed in buildings (e.g., sprinkler systems).

Compressed Air Foam Systems (CAFS), adapted for high-viscosity materials, may be used to provide a mechanism for delivering the viscous fire protection and suppression compositions of the present invention. In this system, the composition is mixed with compressed air to create a consistent, aerated discharge. The resulting foamed composition can cover surfaces effectively and adhere to vertical or irregular surfaces, ensuring comprehensive fire protection and suppression. Modifications to the standard CAFS setup would include reinforced piping and specialized nozzle designs to manage the flow characteristics of the thicker material.

For airborne delivery systems, the spreadable slurry may be placed within a tank or compartment, and then dispersed over large, open areas where the slurry may be operable to cover and suppress larger fires.

It is an object of the present invention to provide a method for making a fire protection and suppression composition operable to extinguish and protect from fires and heat.

It is an object of the present invention to provide a fire protection and suppression composition operable to extinguish and protect from fires using commonly found chemicals.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 provides an embodiment of a delivery mechanism used with the composition, according to an embodiment of the present invention.

FIG. 2 provides a second embodiment of a delivery mechanism used with the composition, according to an embodiment of the present invention.

FIG. 3 provides a third embodiment of delivery mechanisms used with the composition, according to an embodiment of the present invention.

FIG. 4 provides a fourth embodiment of delivery mechanisms used with the composition, according to an embodiment of the present invention.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of a formula for a fire protection and suppression composition and the methods of preparing and using such composition, embodiments of the present disclosure are not limited to use only in this context.

The present disclosure is focused on delivering an unparalleled solution for fire protection and suppression superior to the existing solutions.

The present invention provides a fire protection and suppression composition and the method of making and using of the same.

The fire protection and suppression composition may be in the form of a spreadable slurry formed from common household ingredients such as flour or starch. More specifically, chemicals used to form the slurry may include binders such as carbohydrates, polysaccharides, sodium bicarbonate, simple sugars, and the like.

In some embodiments, the slurry may be operable to extinguish a fire. After being delivered towards a target surface, the slurry may be operable to cover the entire surface area of the fire, preventing it from absorbing more oxygen. As the slurry covers the fire, the water within the slurry evaporates, leaving a thick cohesive layer. The thick cohesive layer may be primarily composed of polysaccharides, sodium bicarbonate, simple sugars, and/or related chemicals. As the cohesive layer dries out, the polysaccharides and sugars may undergo chemical transformations in the present of the sodium bicarbonate in the present of heat, forming a semi-rigid flaky material. The semi-rigid flaky material may be operably knocked off using force or by natural disintegration.

A plant-based flour acts as the primary binder and thickening agent in the composition, providing the bulk and structure needed for the mixture's viscosity. It may be operable to absorb water and form a cohesive paste when mixed with water, allowing the composition to adhere to surfaces and smother flames effectively. Types of flour that can be used include wheat flour, rice flour, or corn flour. Non-gluten alternatives such as almond or chickpea flour that can maintain the thickening properties can also be used. The flour component may be present in the composition in the range of about 30% to about 80% by weight.

A starch constituent may contribute to the composition's viscosity and helps form a gelatinous, viscous consistency when hydrated, enhancing the adherence to targeted surfaces and coverage of the mixture. Starches such as processed starch, potato starch, corn starch, tapioca starch, or other related compounds can be used as the starch constituent. Chemically, starches absorb water and swell, creating a barrier that helps to smother fires by reducing oxygen contact. The starch component may be present in the composition in range of about 15% to about 25% by weight.

A bicarbonate compound constituent provides a fire-suppressing chemical reaction when exposed to high heat. For example, baking soda (sodium bicarbonate) releases carbon dioxide gas when heated, which helps displace oxygen and suppress the fire. This reaction is non-toxic and safe for indoor use, making it an effective fire retardant. Other carbonates with similar fire-suppressing properties, such as potassium bicarbonate, calcium carbonate, sodium bicarbonate, baking soda, and combinations thereof, can serve as the bicarbonate agent.

In some embodiments, the composition may include a simple sugar constituent that may act as a dispersing agent and helps in achieving a uniform consistency in the mixture.

The sugar may act as more of a lattice structure to give a crusty protective barrier creating a space between heat source and fuel.

While simple sugars are not typically associated with fire protection and suppression, in this context, it plays a role in modifying the texture of the composition and ensuring it flows smoothly during application. Simple sugar constituents could include finely ground sucrose, fructose, glucose, dextrose, maltodextrin, and other similar compounds. In some embodiments, the composition may include a simple sugar constituent that may act as a stiffening agent and helps in achieving a more rigid/crusty protective barrier when heated.

The sugar may act as more of a lattice structure to give a crusty protective barrier creating a space between heat source and fuel. While simple sugars are not typically associated with fire protection and suppression, in this context, it plays a role in modifying the texture of the composition and ensuring the application maintains a more rigid and protective barrier. Simple sugar constituents could include water soluble sucrose, fructose, glucose, dextrose, maltodextrin, and other similar compounds.

The combination of these ingredients with water results in a composition that effectively suppresses fires and protects from heat by creating a physical barrier against heat and releasing non-toxic gases that suffocate flames. The flexibility in ingredient ranges and potential substitutes allows for adaptability in formulation while maintaining the desired fire-suppressing properties. The use of food grade ingredients maintains non-toxic, eco-friendly, and all natural characteristics. In some embodiments, the spreadable slurry may be a water-activated mixture with a slightly acidic nature. In such embodiments, the pH of the slurry may range between 7.0 to 7.6. More specifically, the acidic nature of the slurry may be affected by the type of bicarbonate agent being used. In other embodiments, the spreadable slurry may have a different pH.

The method of making the slurry may involve the use of a primary binder, secondary binder, a bicarbonate agent, and/or a simple sugar. In some embodiments, the primary binder and secondary binder may comprise polysaccharides, simple sugars, and a bicarbonate agent, such as sodium bicarbonate. The slurry may be a water-activated dry mixture with about a 2:1:1 ratio, where the primary binder comprises of two parts, the secondary binder and the bicarbonate agent each having a single part. The total dry composition of the mixture may be split into 50% primary binder, 25% secondary binder, and 25% bicarbonate agent. In other embodiments, the dry mixture with about a 2:1:1:1 ratio, where the primary binder provides two parts, the secondary binder provides one part, simple sugars are one part, and the bicarbonate agent is one part. The total dry composition of the mixture may be about 40% primary binder, 20% secondary binder, 20% simple sugars, and 20% bicarbonate agent. Please note that in some implementations the percentages may be in a wider range such as 0-50%.

In some embodiments, the fire protection and suppression composition includes a dry mix consisting primarily of flour, which makes up about 50% to 95% by weight of the mix. The flour serves as the structural and thickening agent and may be selected from wheat flour, rice flour, corn flour, almond flour, or chickpea flour, each of which contributes unique viscosity and adherence characteristics upon hydration. Starch may be added in amounts ranging from 0% to 20% by weight. Suitable starches include corn starch, tapioca starch, and potato starch. Sucrose, present in a range of 0% to 20% by weight, and is preferably added in powdered form. The final core ingredient, bicarbonate, is present at 5% to 50% by weight.

To activate the composition, the dry mix is combined with water at about a 2:1 ratio by weight (dry mix to water). When mixed with water, the hydrated composition resembles a thick slurry or batter and can be effectively deployed across varying terrain and vegetation types including inverted surfaces and small openings like screens or cracks in constructed structures. Optional additives may be included to improve the performance and longevity of the formulation. Potassium sorbate, in concentrations between 0.1% and 0.3%, serves as a food-grade preservative that inhibits mold and yeast growth, thereby extending the shelf life of the dry mix. Rosemary extract, added at levels of 0.05% to 0.2%, nay be added to provide natural antimicrobial activity without introducing synthetic compounds. Additionally, the incorporation of pH-modifying agents such as citric acid or vinegar enhances microbial resistance and may synergize with other components to improve stability. Antifreeze agent such as Propylene Glycol and hydrating agent Hyaluronic Acid may be added in small amounts from 1-20%.

Effective fire protection and suppression depend on matching the appropriate delivery system to specific fire scenarios to optimize response and effectiveness. The versatility of the fire protection and suppression composition allows it to be used in a range of situations. The delivery mechanism for the slurry may include airborne delivery systems such as drones and helicopters that are equipped with mechanisms such as pressurized tanks and hoses, gravity fed systems, radiating manifolds, proprietary tanks, dump tanks, pre-mixed disposable pouches, compact fire extinguishers, and the like.

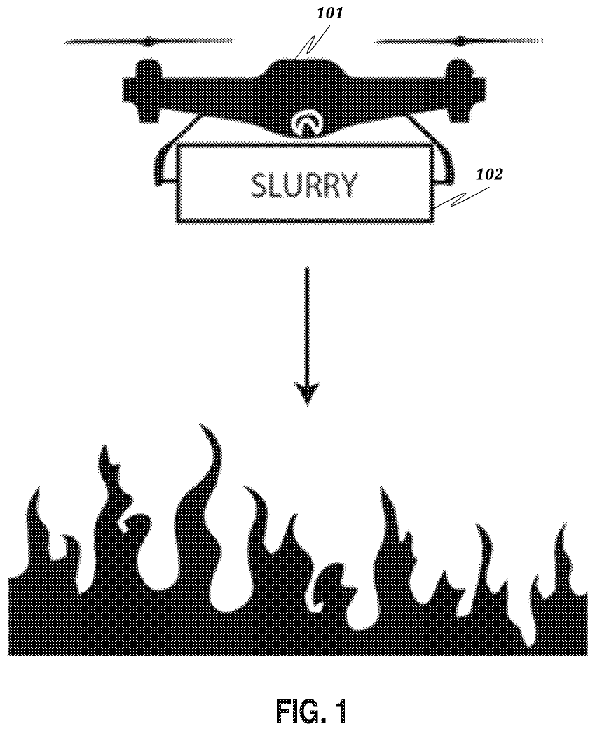

FIG. 1 illustrates a delivery mechanism used with the disclosed composition, according to an embodiment of the present invention.

In this example, a drone 101 may deliver slurry 102 to the fire site.

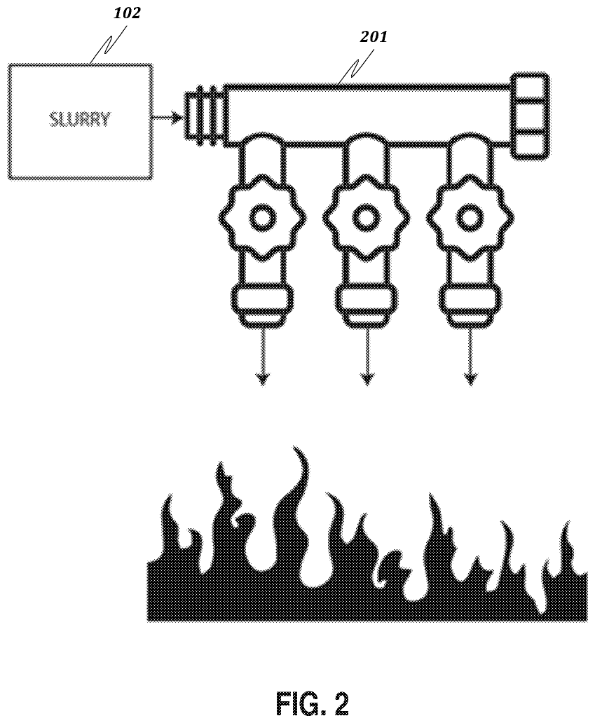

FIG. 2 provides a second embodiment of a delivery mechanism used with the composition, according to an embodiment of the present invention.

In this example, the slurry 102 is dispensed through a radiating manifold 201 with a diameter designed to optimize flow for fire site wide-area coverage of a viscous liquid.

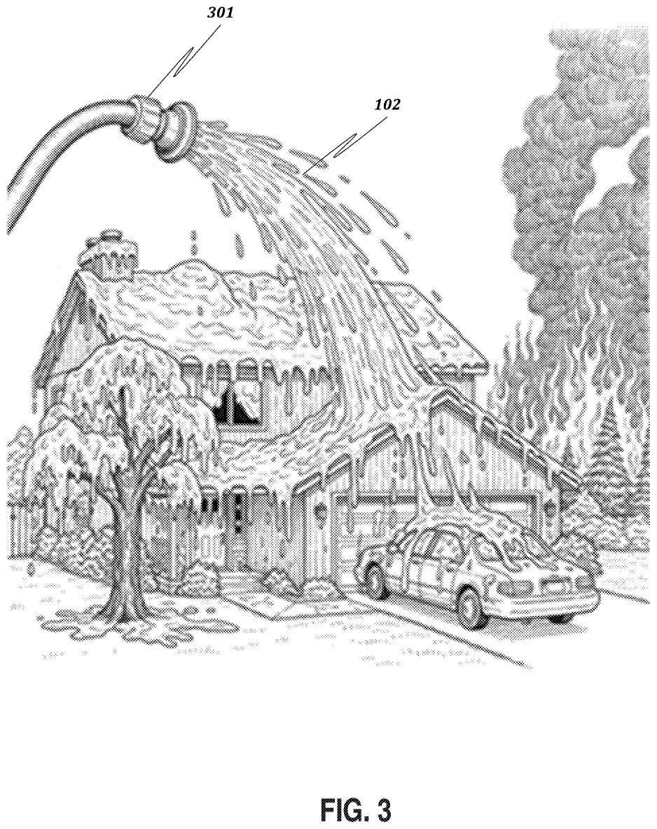

FIG. 3 provides a third embodiment of delivery mechanisms used with the composition, according to an embodiment of the present invention.

In this example, the slurry 102 is delivered through a pump-assisted nozzle 301 for precise control.

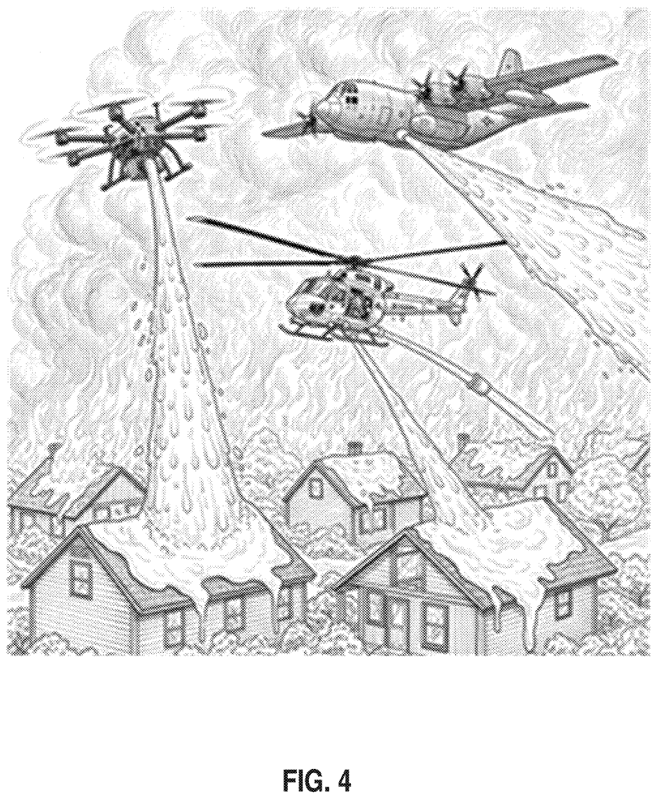

FIG. 4 provides a fourth embodiment of delivery mechanisms used with the composition, according to an embodiment of the present invention.

In this example, the slurry is delivered by drones and aircrafts.

For forest fires, a compressed air foam system (CAFS) may be used. CAFS may deliver wide-area coverage and ensure the composition adheres to vegetation and uneven terrain. The semi-aerated mixture can be propelled over large areas and clings effectively to foliage, creating an oxygen barrier. Vehicle-mounted CAFS units or aircraft equipped with pressurized tanks facilitate rapid deployment over extensive landscapes. The composition is ideally used on the edge of the fire line effectively both extinguishing the fire and preventing advancement into unignited fuel.

As shown in FIGS. 1 and 4, the spreadable slurry may be used within airborne delivery systems, such as a drone. The slurry may be placed within a pressurized tank mounted to the drone. The drone may include a pump-assisted nozzle (not shown) operable to eject the slurry from the tank. The pump-assisted nozzle (not shown) may be operable to handle viscous fluids, allowing the slurry to flow freely through the nozzle towards the target surfaces. Some examples of target surfaces for airborne delivery may include fields, lawns, vehicle surfaces, residential homes, commercial buildings, and the like.

In some exemplary implementations, airborne delivery systems may be used at lower altitudes, and may have a gravity-based system for ejection. The slurry may be stored in a container (e.g., pressure tank, storage tank with pump) on the drone and may be ejected using a drip or dump system or a nozzle.

In house fires (see FIG. 4), pressurized displacement tanks or pump-assisted nozzles are practical for targeted application. Portable pressurized tanks allow firefighters to move easily through a residence, applying the fire protection and suppression composition precisely to affected areas without causing excessive water damage, reignition or need to reapply. Pump-assisted nozzles ensure consistent flow, helping to penetrate deeper into burning materials and extinguish the fire effectively.

In some embodiments, the slurry may be highly viscous, and may be stored in a high-pressure tank that is operable to facilitate ejection of the slurry at a high force. In such embodiments, a nozzle may be incorporated to eject the slurry in a controlled manner. For example, the viscosity of the slurry may range between 1000 to 3000 centipoise.

As shown in FIG. 2, the spreadable slurry may be delivered using a radiating manifold. The radiating manifold may be operable to spread the slurry uniformly from a central source towards multiple outlets. When tackling fires with larger surface areas, radiating manifolds may assist firefighters or other users in controlled distribution of the slurry. Therefore, the fire may be suppressed and extinguished more efficiently and more effectively. Chemical fires require careful consideration due to potential reactions with suppression agents. In such cases, pressurized displacement tanks and auger-based dispensers are suitable for controlled, precise application that minimizes the risk of unintended chemical interactions. The organic and non-toxic nature of the composition ensures safe indoor use, reducing the risk of harmful byproducts.

For oil fires, which are particularly intense and resistant to water-based suppression methods, CAFS and pump-assisted nozzles are ideal. The thick composition and self-foaming forms a protective barrier over the oil, cutting off the oxygen supply and preventing reignition. The semi-aerated discharge from CAFS allows the mixture to adhere to slick surfaces, providing comprehensive coverage.

Car fires require a fast-acting, portable solution. Pressurized displacement tanks are compact and can be stored in emergency vehicles, making them ideal for roadside use. The high-viscosity composition effectively coats engine components and other parts, quickly smothering flames and preventing further damage and safer cleanup for the environment.

Other specialized use cases include kitchen fires, where pressurized tank/extinguisher systems offer an effective solution for immediate deployment without risk of water damage or toxic cleanup, and server room fires, where precise, minimal-residue and soaking methods of suppression is necessary to avoid harming sensitive equipment. The nonconductive nature of the composition also minimizes electrical fires and shock hazards.

Each scenario benefits from the unique properties of the fire protection and suppression composition and the appropriate delivery system, ensuring comprehensive and adaptable fire response capabilities.

It will be readily understood that the components of the disclosed adjustable block, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the socket vertical storage module(s) has been described based upon these preferred embodiments, it would be apparent to those of skill in the art that certain modifications, variations, and alternative constructions would be apparent.

While preferred embodiments of the present device have been described, it is to be understood that the embodiments described are illustrative only and the scope of the application is to be defined solely by the appended claims when considered with a full range of equivalents and modifications thereto.

What is claimed:

1. A fire suppression composition comprising a dry mix of food grade ingredients of approximately 30-50% flour, 5-50% starch, 5-25% simple sugar, 5-50% bicarbonate agent, 0-20% antifreeze comprising as propylene glycol, and 0-20% hydrate comprising hyaluronic acid wherein the dry mix is combined with water at a ratio of about 2:1 (dry mix to water) to form a viscous fire suppression and protection agent.

2. The composition of claim 1, wherein the flour is selected from the group consisting of: wheat flour, rice flour, corn flour, almond flour, and chickpea flour.

3. The composition of claim 1, wherein the starch consists of one or more of: corn starch, tapioca starch, and potato starch.

4. The composition of claim 1, wherein the simple sugar includes one or more of powdered form of: sucrose, fructose, glucose, maltose, dextrose, and maltodextrin.

5. The composition of claim 1, wherein the bicarbonate agent includes one or more of: baking soda, baking powder, potassium bicarbonate, and calcium bicarbonate.

6. The composition of claim 1, wherein the composition further comprises 0.1% to 0.3% potassium sorbate for extended shelf-life.

7. The composition of claim 1, wherein the composition further comprises 0.05% to 0.2% rosemary extract for natural antimicrobial properties.

8. The composition of claim 1, wherein the composition includes a pH-modifying agent selected from any of citric acid, vinegar to enhance microbial stability.

9. A method of suppressing forest fires comprising: applying a viscous fire suppression composition to the affected area, the composition comprising a dry mix of approximately 30-50% flour, 15-25% starch, 15-25% simple sugar, and 15-25% bicarbonate agent, combined with water at a 2:1 ratio (dry mix to water).

10. The method of claim 9, wherein the composition is applied using a vehicle-mounted compressed air foam system (CAFS).

11. The method of claim 9, wherein the composition is aerially deployed using aircraft equipped with pressurized tanks.

12. The method of claim 9, wherein the composition adheres to vegetation and terrain to form a barrier that suppresses oxygen flow and heat transfer.

13. The method of claim 9, wherein the application includes strategic placement along firebreaks to prevent fire spread.

14. The method of claim 9, wherein the application includes strategic placement on structures, vehicles, combustible materials or heat sensitive materials for protection against heat and flame.

15. The method of claim 9, wherein the composition is pre-treated with potassium sorbate for enhanced shelf-life before application.

16. The method of claim 9, wherein the viscosity of the composition is adjusted by heating prior to deployment.

17. The method of claim 9, wherein the composition is dispensed through a nozzle with a diameter designed to optimize flow for wide-area coverage of a viscous liquid.

18. A method of suppressing indoor fires comprising: deploying a viscous fire suppression composition within a building, the composition comprising a dry mix of approximately 30-50% flour, 5-50% starch, 5-25% simple sugar, and 5-50% bicarbonate agent, 0-20% antifreeze such as propylene glycol, and 0-20% hydrate such as hyaluronic acid wherein the dry mix is combined with water at a ratio of about 2:1 ratio (dry mix to water) to form a viscous fire suppression and protection agent.

19. The method of claim 18, wherein:
the composition is deployed using a portable pressurized displacement tank;
the composition is applied via a pump-assisted nozzle for precise control;
the composition is supplemented with citric acid to improve microbial stability; and
the composition is used in combination with a gravity-fed system for continuous application

20. The method of claim 18, wherein the composition is dispensed through nozzles configured to handle high-viscosity fluids.
